(19) United States
(12) Patent Application Publication
(10) Pub. No.: US 2010/0121551 A1
(43) Pub. Date: May 13, 2010

(54) METHOD, SYSTEM, AND PROGRAM PRODUCT FOR FACILITATING VEHICLE FUELING BASED ON VEHICLE STATE

(75) Inventors: Gregory J. Boss, American Fork, UT (US); Peter G. Finn, Brampton (CA); Rick A. Hamilton, II, Charlotteesville, VA (US); Brian M. O'Connell, Cary, NC (US); James W. Seaman, Falis Church, VA (US); Keith R. Walker, Austin, TX (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/267,690

(22) Filed: Nov. 10, 2008

(51) Int. Cl. G06G 7/70

(52) U.S. Cl. 701/99

(57) ABSTRACT

A system, method, and program product for facilitating fueling a vehicle includes sensing a state of the ignition of a vehicle and affecting fueling of the vehicle based on the state of the ignition. In one instance, the system, method, and program product are part of a computing system of the vehicle. In another instance, the system, method, and program product are part of a fuel pump employed to add fuel to the vehicle. In another aspect, the state of one or more of the fuel cap and the fuel pump are used to affect the state of the ignition. The state of the ignition may also be used to affect the state of another device external to the vehicle.

### FIELD OF THE INVENTION

The present invention generally relates to fueling a vehicle and, more particularly, to a method, system, and program product for facilitating fueling of a vehicle based on a state of the vehicle and/or another apparatus.

### BACKGROUND OF THE INVENTION

Vehicles, such as automobiles, use fuel during operation. On the surface, fueling a vehicle seems straightforward and fairly inconsequential, and many vehicle manufacturers provide fueling instructions in publications such as vehicle user guides. However, fuel is combustible. Thus, although appearing straight forward and fairly inconsequential, the manner and surrounding conditions may influence the probability of inadvertent combustion of the fuel. In addition, using a fuel with characteristics that are different from the characteristics recommended by the manufacturer or using an improper fuel may result in a myriad of problems including, but not limited to, undesired combustion and/or costs associated with repairs.

### SUMMARY OF THE INVENTION

In one aspect, a system includes a first component that senses a state of the ignition of the vehicle and a second component that selectively allows fuel to be provided to the vehicle based on the state of the ignition.

In another aspect, a method includes sensing a state of an ignition of the vehicle and affecting the ability to add fuel to the vehicle based on the state of the ignition.

In another aspect, a method includes producing computer executable program code, storing the code on a computer readable medium, and providing the program code to be deployed and executed on a computer system. The program code comprising instructions which, when executed on the computer system, cause the computer system to sense a parameter indicative of a state of an ignition of the vehicle, wherein the state indicates whether the ignition is on or off and allow fuel to be added to the vehicle when the ignition is off and inhibit fuel from being added to the vehicle when the ignition is on.

In another aspect, a method for deploying an application for facilitating fueling a vehicle includes providing a computer infrastructure being operable to sense a parameter indicative of a state of an ignition of the vehicle, wherein the state indicates whether the ignition is on or off and allow fuel to be added to the vehicle when the ignition is off and inhibit fuel from being added to the vehicle when the ignition is on.

### BRIEF DESCRIPTION OF THE DRAWINGS

These and other features of this invention will be more readily understood from the following detailed description of the various aspects of the invention taken in conjunction with the accompanying drawings in which:

FIG. 1 illustrates a system of a vehicle that facilitates fueling of a vehicle.

FIG. 2 illustrates a system of a vehicle that uses wireless communication to facilitate fueling of a vehicle.

FIG. 3 illustrates a system of a fuel pump that facilitates fueling of a vehicle.

FIG. 4 illustrates a method performed in a vehicle to facilitate fueling of a vehicle.

FIG. 5 illustrates a method performed in a fuel pump to facilitate fueling of a vehicle.

FIG. 6 illustrates an exemplary computerized implementation of the system that facilitates fueling of a vehicle.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience purposes, the Detailed Description of the Invention has the following sections

I. General Description

II. Computerized Implementation

### I. General Description

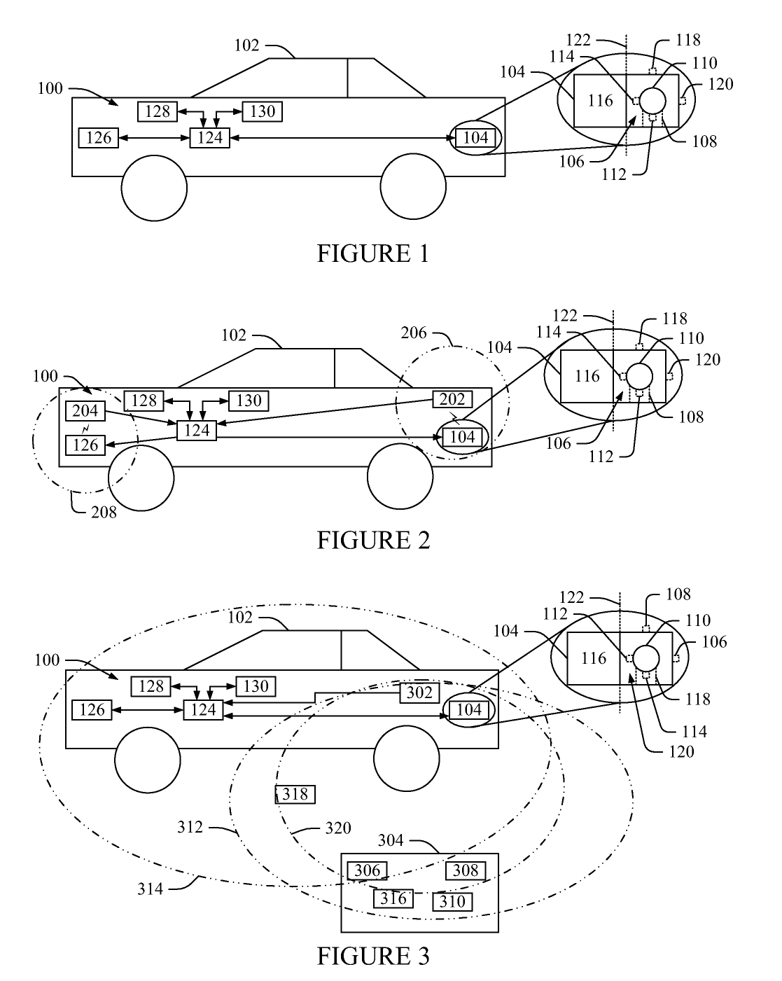

FIG. 1 illustrates a system 100 that facilitates fueling a vehicle such as a car 102. It is to be appreciated that this system can be used with other types of vehicles, and/or various apparatuses, equipment, and the like, including those that use and/or store fuel and/or another material, including a gel, a solid, and/or a different liquid. It is also to be appreciated that the system 100 may include, be part of, and/or communicate with other systems, subsystems, microprocessors, controllers, modules, etc. that control, monitor, diagnose, etc. various systems and/or subsystems of the vehicle such as a main computer, an engine control system, a transmission control system, etc.

The system 100 includes a fuel entry region 104 that includes a compartment 106 that houses a fuel entry port 108, a fuel cap 110 for the entry port 108, a fuel cap lock 112, and a fuel cap sensor 114 (third component) that senses the state of the fuel cap 110. The system 100 also includes a fuel door 116, a fuel door lock 118, and a fuel door sensor (third component) 120 that senses the state of the fuel door 116. In one non-limiting instance, the fuel door 116 pivots about a pivot axis 122 between a first or closed position in which the fuel door 116 is closed with respect to the compartment 106 and a second or open position (shown) in which the fuel door 116 is open with respect to the compartment 106.

It is to be appreciated that one or more of the fuel door lock 118, the fuel door sensor 120, the fuel cap lock 112, and the fuel cap sensor 114 may be omitted. In addition, one or more other sensors and locks for one or more other components may be included with and/or work in connection with one or both of the fuel door lock 118 and sensor 120 and/or the fuel cap lock 112 and sensor 114. Furthermore, the illustrated location and shape of the compartment 106, the fuel entry port 108, the fuel cap 110, the fuel cap lock 112, the fuel cap sensor 114, the fuel door 116, the fuel door lock 118, and/or the fuel door sensor 120 are provided for explanatory purposes and may be otherwise located and shaped in other implementations.

For the sake of brevity and clarity, the following describes the illustrated example, which includes both the fuel door lock and sensor 118 and 120 and the fuel cap lock and sensor 112 and 114. However, as noted above, one or more of the fuel door lock 118, the fuel door sensor 120, the fuel cap lock 112, and the fuel cap sensor 114 may be omitted in other implementations.

The fuel door sensor 120 senses the state of the fuel door 116. For example, the fuel door sensor 120 may sense whether the fuel door 116 is open or closed. Fuel door sensor 120 conveys a signal indicative of the state of the fuel door 116 and/or receives information such as a request for the state of the fuel door 116, sensor calibration parameters, a control signal, etc. The fuel door lock 118 locks and unlocks the fuel door 116. When locked, the fuel door 116 is inhibited from being opened, and when unlocked, the fuel door 116 can be opened. The fuel door lock 116 conveys a signal indicative of the state of the fuel door lock 116 (e.g., opened or closed) and/or receives information such as a request for the state of the fuel door lock 116, a control signal, a diagnostic signal, etc.

The fuel cap sensor 114 senses a state of the fuel cap 110. For example, the fuel cap sensor 114 senses the presence and the absence of the fuel cap 110. As such, the fuel cap sensor 114 senses when the fuel cap 110 is installed and removed. Fuel cap sensor 114 conveys a signal indicative of the state of the fuel cap 110 and/or receives information such as a request for the state of the fuel cap 110, sensor calibration parameters, a control signal, etc. The fuel cap lock 112 locks and unlocks the fuel cap 110. When locked, the fuel cap 110 is inhibited from being removed. When unlocked, the fuel cap 110 can be removed. The fuel cap lock 112 conveys a signal indicative of the state of the fuel cap lock 112 (e.g., locked or unlocked) and/or receives information such as a request for the state of the fuel cap lock 112, a control signal, a diagnostic signal, etc.

Various types of sensors may be used with the fuel door 116 and the fuel cap 110. For example, the sensors may be part of and/or communicate with a magnetic switch. As such, opening the fuel door 116 and removing the fuel cap 110 and/or closing the fuel door 116 or returning the fuel cap 110 may result in opening or closing an electrical circuit and/or inducing an electrical signal to indicate the state of the fuel door 116 and fuel cap 110. In another example, the fuel door 116 and the fuel cap 110 may include one or more members such as protrusions that open and close an electrical circuit, for example, via moving electrical contacts out of and into electrical communication with the electrical circuit. In yet another example, one or more encoders are used to sense open and closed positions of the fuel door 116 and removed and returned states of the fuel cap 110. In yet another example, one or more radio frequency identification (RFID) tags or the like emit or stop emitting a signal when the fuel door 116 is opened or closed and the fuel cap 110 is removed or returned. It is to be understood that the above examples are not limiting and other sensors are also contemplated herein.

Various types of locks can be used with the fuel door 116 and the fuel cap 110. For example, the locks may include an actuator such as a solenoid that reciprocates a plunger between locked and unlocked positions. For example, the fuel door 116 and the fuel cap 110 may include a material free region such as a hole or slot through which the plunger reciprocates in and out of to lock and unlock the fuel door 116 and fuel cap 110. In another example, a locking component may forcibly engage the fuel door 116 and fuel cap 110. For instance, the locking component may slidably engage the fuel door 116 and fuel cap 110, pivotably engage the fuel door 116 and fuel cap 110, rotatably engage the fuel door 116 and fuel cap 110, and/or otherwise engage the fuel door 116 and fuel cap 110. In yet another example, a magnetic locking mechanism may be employed in which the fuel door lock 118 and the fuel cap lock 112 may magnetically hold the fuel door 116 and the fuel cap 110 in place. It is to be understood that the above examples are not limiting and other locks are also contemplated herein.

A computing component 124, such as a microprocessor, a control module, a computer, or the like communicates with the fuel door sensor 120, the fuel door lock 118, the fuel cap sensor 114, the fuel cap lock 112, and an ignition or ignition system 126, which may operate, for example, in conjunction with a physical mechanism such as a key, a remote starter, a keypad, and/or the like to turn the vehicle on and off. Such communication can be through wired and/or wireless communications. The ignition system 126 may include one or more sensors (e.g., a first sensor) similar to those described herein that provide an indication of the state of the ignition system. For instance, a sensor that provides a signal when the ignition is turned on and/or a sensor that provides a signal when the ignition is turned off may work in conjunction with the ignition system 126. Such a sensor may provide an electrical, magnetic signal, and/or radio frequency (RF) based signal.

In one instance, the computing component 124 (second component) conveys a (first) signal indicative of a desired state of the fuel door lock 118 and/or the fuel cap lock 112 to the fuel door lock 118 and/or the fuel cap lock 112 based on a state of the ignition and/or other information such as a state of an apparatus internal or external to the vehicle. For example, the signal may indicate whether the fuel door lock 118 and the fuel cap lock 112 should remain in an unlocked or locked state, toggle to the unlocked state, or toggle to the locked state based on the state of the ignition. By way of example, if the ignition is on, the computing component 124 may convey a signal that invokes the fuel door lock 118 and the fuel cap lock 112 to lock or remain locked. Additionally or alternatively, the computing component 124 may convey a signal that invokes the fuel door lock 118 and the fuel cap lock 112 to unlock or remain unlocked, for example, based on the state of the ignition. As such, the computing component 124 may control access to the fuel entry port 108, for example, based on the state of the ignition by invoking the locks 118 and 112 to lock or unlock.

In another instance, the computing component 124 conveys a signal indicative of a desired state of the ignition to the ignition system 126 based on the state of the fuel door 116 and the fuel cap 110. For example, the signal may indicate whether the ignition should be allowed to toggle to an on state or remain in an off state. For instance, if the fuel door 116 and the fuel cap 110 are determined to be opened and off, via the fuel door sensor 120 and the fuel cap a sensor 114, the signal may indicate that the ignition should be inhibited from transitioning to the on state. In another instance, if the fuel door 116 and the fuel cap 110 are determined to be closed and on, via the fuel door sensor 120 and the fuel cap sensor 114, the signal may indicate that the ignition can transition to the on state.

In instances in which the fuel locks 118 and 112 are omitted, the computing component 124 may send a signal to the ignition system 126 when the ignition is on to that indicates that the fuel door 116 is open and the fuel cap 110 is removed, when the fuel door 116 is open and the fuel cap 110 is removed. In response, the ignition system 120 may automatically transition to the off state. Such information can be obtained from the fuel door sensor 120 and the fuel cap sensor 114.

The system 100 may also include a storage component 128 that stores information such as the state of the fuel door 116, the fuel door lock 118, the fuel cap 110, the fuel cap lock 112, and/or the ignition. This information can be stored along with date and time stamps, other vehicle information such as service information, vehicle identification information, user information, etc. Such information can be retrieved from the storage component 128 through devices such as a laptop, a handheld computer, a personal data assistant, a desktop computer, a cell phone, a server, a network, and the like via a wireless and/or wired communications channel(s).

The system 100 may also include a notification component 130 that provides a notification regarding the state of the fuel door 116, the fuel cap 110, and/or the ignition. Such notification may include a visual notification, for example, displayed on a display device of the car and/or external to the car. Such visual notification may include an alphanumeric character(s) indication, a light pattern including a color pattern, an on/off frequency pattern and the like, a code, etc. Additionally or alternatively, the notification may include an audible notification such as a beep, a human perceptible message, etc. Additionally or alternatively, the notification may include invoking a device external to the vehicle such as a cell phone, a personal data assistant, etc. to provide a notification regarding the state of the fuel door 116, the fuel cap 110, and/or the ignition.

In FIG. 2, the system 100 includes wireless communication devices 202 and 204. The wireless communication devices 202 and 204 wirelessly communicate with components within respective communication zones 206 and 208. As illustrated, the communication zones 206 and 208 are circular in shape and cover different sub-regions of the vehicle. However, it is to be understood that the illustrated communication zones 206 and 208 are provided for non-limiting, explanatory purposes. In other examples contemplated herein the communication zones 206 and 208 are elliptically, irregularly, or otherwise shaped and/or cover smaller or larger zones, including the entire vehicle and zones also covered by other wireless communication devices.

In this example, the communication zone 206 of the wireless communication device 202 encompasses the fuel door sensor 120, the fuel door lock 118, the fuel cap sensor 114, and the fuel cap lock 112. As such, the wireless communication device 202 can communicate with the fuel door sensor 120, the fuel door lock 118, the fuel cap sensor 114, and the fuel cap lock 112. The communication zone 208 of the wireless communication device 204 encompasses the ignition system 126. As such, the wireless communication device 204 can communicate with the ignition system 126, for example, with a radio frequency identification (RFID) tag or the like that emits information about the state of the ignition. As shown, the wireless communication devices 202 and 204 also communicate with computing component 124. It is to be appreciated that communications between the computing component 124 and the ignition system 126, the fuel door sensor 120, the fuel door lock 118, the fuel cap sensor 114, and/or the fuel cap lock 112 can be direct between such components as described above and/or indirect via the wireless communications devices 204 and 206 and/or other components.

In the illustrated example, the wireless communications devices 204 and 206 sense the state of the ignition system 126, the fuel door sensor 120, the fuel door lock 118, the fuel cap sensor 114, and/or the fuel cap lock 112 and provide the state information to the computing component 124. The computing component 124 communicates with the ignition system 126, the fuel door sensor 120, the fuel door lock 118, the fuel cap sensor 114, and/or the fuel cap lock 112 based on the state information received from the wireless communications devices 204 and 206. Such communication is as described above. In one instance, the computing component 124 may receive state information from both the wireless devices 204 and 206, the ignition system 126, the fuel door sensor 120, the fuel door lock 118, the fuel cap sensor 114, and/or the fuel cap lock 112.

FIG. 3 shows an example in which the system 100 communicates with one or more other systems, devices, apparatuses, etc., which may be internal or external to the vehicle. In this example, a wireless communication device 302 includes a radio frequency identification (RFID) reader. In another example, the wireless communication device 302 additionally or alternatively includes other wireless technology(s). In addition, the wireless communication devices 202 and 204 and/or other wireless communication devices may be used instead of the wireless communication device 302. As such, the wireless communication device 302 can communicate with the other components as described above. In this example, the fuel door sensor 120, the fuel cap sensor 114, and the ignition system 126 include RFID tags that emit information related to their respective states. The wireless communication device 302 can read the tags and provide the state information to the computing component 124 as described above.

A fuel pump 304 includes a fuel pump RFID reader 306, a fuel pump RFID tag 308, and a fuel pump controller 310. As shown, the wireless communication device 302 is configured such that its communication zone 312 can read the fuel pump RFID tag 308. As such, the wireless communication device 302 and, thus, the computing component 124 may be apprised of the state of the fuel pump 304 from the fuel pump RFID tag 308. In addition, the fuel pump RFID reader 306 is configured such that its communication zone 314 able to read from the RFID tags of the fuel door sensor 120 and the fuel cap sensor 114. As such, the fuel pump RFID reader 306 and, hence, the fuel pump controller 310 may be apprised of the state of the ignition, the fuel door 116, and/or the fuel cap 110. In another example, either the vehicle obtains information about the fuel pump 304 or the fuel pump 304 obtains information about the vehicle. Accordingly, not all of above components are included in some examples.

In one instance, when the fuel pump dispenser is disengaged from its holster or otherwise and/or fuel is being added to the vehicle, the computing component 124, having received information indicating the state of the fuel pump dispenser from the fuel pump RFID tag 308, inhibits an off ignition from turning on. Where the fuel dispenser can be removed from its holster and used to add fuel to the vehicle even though the ignition is on, the computing component 124, being apprised of the state of the fuel pump 304, may send a signal to the ignition system 126 to turn the ignition off. When receiving information indicating that fueling has terminated and/or that the fuel dispenser has been returned to its holster, the computing component 124 sends a signal indicating the ignition may be turned on.

The notification component 130 of the vehicle may also provide a notification regarding the state of the fuel pump 304.

Additionally or alternatively, the fuel pump controller 310 may be apprised of the state of the ignition from a RFID sensor of the ignition system as read by the fuel pump RFID reader 306. The fuel pump controller 310, having received information indicating that the vehicle's ignition is on, may inhibit fuel dispenser from being disengaged from its holster and/or otherwise from dispensing fuel. When receiving information indicating that the vehicle is off, the fuel pump controller 310 may allow the fuel dispenser to be removed from its holster and fuel can be transferred through the fuel dispenser to the vehicle.

Additionally or alternatively, the fuel pump controller 310 may be apprised of the state of the fuel door 116 and/or the fuel cap 110 via the RFID tags of the fuel door sensor 120 and the fuel cap sensor 114. The fuel pump controller 310, having received information indicating that the fuel door 116 and/or the fuel cap 110 is locked, which indicates that the ignition is on, inhibits the fuel dispenser from being removed from its holster and/or fuel from being dispensed from the fuel pump dispenser. When receiving information indicating that the fuel door 116 is open and/or the fuel cap 110 is removed, which indicates the ignition is off, the fuel pump controller 310 allows the fuel dispenser to be removed from its holster and fuel to be transferred through the fuel dispenser to the vehicle.

A fuel pump notification component 316 may provide a notification regarding the state of the fuel pump 304, the fuel door 116, the fuel cap 110, and/or the ignition. Similar to the notification component 130 of the vehicle, the fuel pump notification component 316 may include a visual notification and/or an audible notification, invoke another device to provide a notification of such state, and/or otherwise provide a notification regarding the state.

It is to be appreciated that various information can be communicated between the vehicle and the fuel pump 304. For instance, information regarding the type of fuel, for example, leaded gasoline, unleaded gasoline, diesel, ethanol, etc. and/or the characteristics of the fuel, for example, 85, 86, 87, 88, or 89 octane, gasoline/ethanol mixture, etc. recommended by the manufacturer may be obtained from the vehicle, for example, from a RFID tag. Upon obtaining such information, the fuel pump 304 may allow the user to pump fuel from the fuel pump 304, inhibit the user from pumping fuel from the fuel pump 304, and/or prompt the user via the fuel pump notification component 316 as to whether or not the user desires to use the fuel pump 304. In addition, the fuel pump 304 may display a message via the fuel pump notification component 316. Such message may include information such as the anticipated affects of using such fuel, such as the anticipated efficiency (e.g., miles per gallon), deleterious affects from using an incorrect fuel, an octane recommendation, a warning that an incorrect type of fuel has been selected, a warning that a less than optimal octane has been selected, etc.

In one instance, when selecting the correct type of fuel and a recommended octane level, a green light may illuminate. When selecting the correct type of fuel and an octane level outside of the recommended range, a yellow light may illuminate. When selecting an incorrect type of fuel, a red light may illuminate. Additionally or alternatively, an audible message and/or a message on a display or monitor that indicates such information may be provided.

In addition, the fuel pump tag 308 may provide information such as a fuel station identifier, the date, the time of day, the number of gallons of fuel, the cost of the fuel, etc. This information along with the fuel type, fuel characteristics, and/or other information communicated to the vehicle can be stored in the storage component 128 of the vehicle. Such information can be accessed by a user. In addition, the stored information can be analyzed to determine various fueling patterns as well as other patterns associated with fueling. For example, patterns corresponding to the fuel station, the type of fuel, the characteristics of the fuel, the time between fueling, the average amount of fuel purchased, etc. can be determined. The user of the vehicle may be apprised of such patterns.

In another instance, one or more other devices 318 such as a cell phone may include wireless technology for communicating with the vehicle and/or fuel pump 304. With information about the one or more other devices 318, the computing component 124 and/or the fuel pump controller 310 may variously control the fuel door lock 118, the fuel cap lock 112, and/or the fuel pump 304 as described herein, and/or the cell phone, for example, by automatically powering down or otherwise controlling the power state of the cell phone. Additionally or alternatively, information obtained about the vehicle and/or the fuel pump 304 such as state information by the one or more other devices 318, for example, information within the communication zone 320 of the one or more other devices 318, can be used by the one or more other devices 318 to control the vehicle and/or the fuel pump 304.

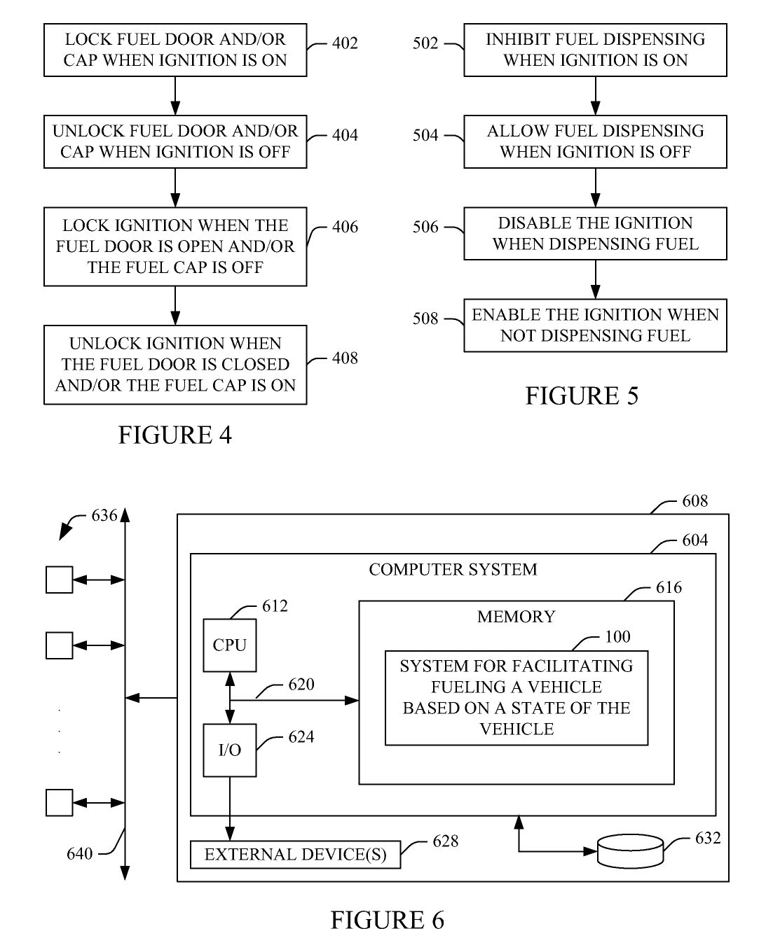

Operation of an example system is described in connection with FIG. 4. At 402, assuming the ignition is off, the fuel cap 110 is on, and the fuel door 116 is shut, when the ignition is toggled to the on state, the computing component 124 invokes the fuel door lock 118 and/or the fuel cap lock 112 to lock. As noted above, when locked, the fuel door 116 is inhibited from being opened and the fuel cap 110 is inhibited from being removed. At 404, when the ignition transitions to the off state, the computing component 124 invokes the fuel door lock 118 and/or the fuel cap lock 112 to unlock. When unlocked, the fuel door 116 can be opened and the fuel cap 118 can be removed.

At 406, when the fuel door 116 is opened and the fuel cap 110 is removed, the computing component 124 notifies the ignition system 126 of such, and the ignition is locked or otherwise inhibited from transitioning to an on state. In addition to the above techniques of becoming apprised of the state of the fuel door 116 and the fuel cap 110, other examples include a signal sent by the fuel door sensor 110 and the fuel cap sensor 114 to the computing component 124 when the fuel door 116 is opened and the fuel cap 110 is removed. In another instance, the computing component 124 periodically polls the state of the fuel door 116 and the fuel cap 110 and/or sends a state information request to the by the fuel door sensor 120 and the fuel cap sensor 112. Other techniques may also be used.

At 408, when the fuel cap 110 is returned and the fuel door 110 is closed, the computing component 124 notifies the ignition system 126 of such. Similarly, the computing component 124 is apprised of the state of the fuel door 116 and the fuel cap 110 by a signal sent by the fuel door sensor 120 and the fuel cap sensor 114 to the computing component 124 when the fuel cap 110 is returned and the fuel door 116 is closed. In addition, the computing component 124 periodically polls the state of the fuel door 116 and the fuel cap 110 and/or sends a state information request to the by the fuel door sensor 120 and the fuel cap sensor 112. When notified as such, the ignition system 126 unlocks or otherwise can transition to the on state.

Another example system is described in connection with FIG. 5. At 502, a fuel pump is inhibited from dispensing fuel when the ignition is on. The fuel pump is apprised of the state of the ignition as described above. Alternatively, the ignition is automatically turned off when the fuel is dispensed as described above. At 504, when the ignition is off, fuel can be dispensed as described above. At 506, when fuel is being dispensed, the ignition is disabled as described above. At 508, when fueling ceases, the ignition is enabled as described above.

It is to be appreciated that the system 100 may be employed to facilitate ensuring proper fueling of the vehicle. As such, the user is able add fuel to the vehicle when the ignition off. When the ignition is on, however, the user may be inhibited from adding fuel by locking the fuel door 116 and the fuel cap 110 as described above. In addition, the fuel door 116 is open and the fuel cap 110 is removed so that the user can add fuel, the user may be inhibited from turning the vehicle on. The foregoing may help reduce the chance of combustion of the fuel due to the vehicle running. Of course, the system may also be used for other purposes. In addition, the fuel door 116 locking, fuel cap 112 locking, and/or ignition inhibiting can be overridden by an authorized user such as the owner, a service technician, and the like.

A method for facilitating fueling of a vehicle includes sensing a state of an ignition of the vehicle and affecting the ability to add fuel to the vehicle based on the state of the ignition. In one instance, sensing the state and affecting the ability to add fuel are performed within a computing system of a vehicle. In another instance, affecting the ability to add fuel includes inhibiting access to a fuel entry port of the vehicle when the ignition is on. In another instance, affecting the ability to add fuel includes inhibiting the ignition from turning on when a fuel cap is removed. In another instance, affecting the ability to add fuel includes inhibiting the ignition from turning on when fuel is being added to the vehicle. In another instance, sensing the state and affecting the ability to add fuel are performed within a fuel pump. In another instance, affecting the ability to add fuel includes inhibiting fuel dispensing when the ignition is on.

A method includes producing computer executable program code, storing the code on a computer readable medium, and providing the program code to be deployed and executed on a computer system, the program code comprising instructions which, when executed on the computer system, cause the computer system to: sense a parameter indicative of a state of an ignition of a vehicle, wherein the state indicates whether the ignition is on or off, and allow fuel to be added to the vehicle when the ignition is off and inhibit fuel from being added to the vehicle when the ignition is on.

A method deploying an application for facilitating fueling a vehicle includes providing a computer infrastructure being operable to: sense a parameter indicative of a state of an ignition of the vehicle, wherein the state indicates whether the ignition is on or off, and allow fuel to be added to the vehicle when the ignition is off and inhibit fuel from being added to the vehicle when the ignition is on.

### II. Computerized Implementation

Referring now to FIG. 6, an exemplary computerized implementation includes a computer system 604 deployed within a computer infrastructure 608 such as one existing with the vehicle 102 described above. This is intended to demonstrate, among other things, that the present invention could be implemented within a network environment (e.g., the Internet, a wide area network (WAN), a local area network (LAN), a virtual private network (VPN), etc.), or on a stand-alone computer system.

In the case of the former, communication throughout the network can occur via any combination of various types of communication links. For example, the communication links can comprise addressable connections that may utilize any combination of wired and/or wireless transmission methods.

Where communications occur via the Internet, connectivity could be provided by conventional TCP/IP sockets-based protocol, and an Internet service provider could be used to establish connectivity to the Internet. Still yet, computer infrastructure 608 is intended to demonstrate that some or all of the components of implementation could be deployed, managed, serviced, etc. by a service provider who offers to implement, deploy, and/or perform the functions of the present invention for others.

As shown, the computer system 604 includes a processing unit 612, a memory 616, a bus 620, and input/output (I/O) interfaces 624. Further, the computer system 604 is shown in communication with external I/O devices/resources 628 and storage system 632. In general, the processing unit 612 executes computer program code, such as the code to implement various components of the system 100, which is stored in memory 616 and/or storage system 632. It is to be appreciated that two or more, including all, of these components may be implemented as a single component.

While executing computer program code, the processing unit 612 can read and/or write data to/from the memory 616, the storage system 632, and/or the I/O interfaces 624. The bus 620 provides a communication link between each of the components in computer system 604. The external devices 628 can comprise any devices (e.g., keyboard, pointing device, display, etc.) that enable a user to interact with computer system 604 and/or any devices (e.g., network card, modem, etc.) that enable computer system 604 to communicate with one or more other computing devices.

The computer infrastructure 608 is only illustrative of various types of computer infrastructures for implementing the invention. For example, in one embodiment, computer infrastructure 608 comprises two or more computing devices (e.g., a server cluster) that communicate over a network to perform the various process steps of the invention. Moreover, computer system 604 is only representative of various possible computer systems that can include numerous combinations of hardware.

To this extent, in other embodiments, computer system 604 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively.

Moreover, the processing unit 612 may comprise a single processing unit, or be distributed across one or more processing units in one or more locations, e.g., on a client and server. Similarly, the memory 616 and/or the storage system 632 can comprise any combination of various types of data storage and/or transmission media that reside at one or more physical locations.

Further, I/O interfaces 624 can comprise any system for exchanging information with one or more of the external device 628. Still further, it is understood that one or more additional components (e.g., system software, math co-processing unit, etc.) not shown in FIG. 6 can be included in computer system 604. However, if computer system 604 comprises a handheld device or the like, it is understood that one or more of the external devices 628 (e.g., a display) and/or the storage system 632 could be contained within computer system 604, not externally as shown.

The storage system 632 can be any type of system (e.g., a database) capable of providing storage for information under the present invention. To this extent, the storage system 632 could include one or more storage devices, such as a magnetic disk drive or an optical disk drive. In another embodiment, the storage system 632 includes data distributed across, for example, a local area network (LAN), wide area network (WAN) or a storage area network (SAN) (not shown). In addition, although not shown, additional components, such as cache memory, communication systems, system software, etc., may be incorporated into computer system 604.

Shown in the memory 616 of computer system 604 is the system 100, which includes the components and performs that functions discussed above. The system 100 communicates with external entities 636 such as fuel pump computing systems, electronic devices such as cell phones, personal data assistants, etc., a service station computer, other apparatuses external to the vehicle, etc. over a path 640, which may be wired (as shown) or wireless.

While shown and described herein as a method and a system, it is understood that the invention further provides various alternative embodiments. For example, in one embodiment, the invention provides a computer-readable/useable medium that includes computer program code to enable a computer infrastructure to sense and track fluid replacement. To this extent, the computer-readable/useable medium includes program code that implements each of the various process steps of the invention.

It is understood that the terms “computer-readable medium” or “computer useable medium” comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 616 (FIG. 6) and/or the storage system 632 (FIG. 6) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider could offer to manage the system 100. In this case, the service provider can create, maintain, support, etc., a computer infrastructure, such as the computer infrastructure 608 (FIG. 6) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for executing the system 100. In this case, a computer infrastructure, such as computer infrastructure 608 (FIG. 6), can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as computer system 604 (FIG. 6), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A system, comprising:
a first component configured to sense a state of an ignition of a vehicle; and
a second component configured to selectively allow fuel to be provided to the vehicle based on the state of the ignition.

2. The system of claim 1, wherein the first and second components are part of a computing system of the vehicle, and the second component is configured to selectively provide access to a fuel entry port of the vehicle based on the state of the ignition.

3. The system of claim 2, wherein the second component is configured to emit a first signal that invokes at least one of a fuel door lock to lock or a fuel cap lock to lock when state of the ignition indicates that the ignition is on and a second signal that invokes the at least one of the fuel door lock or the fuel cap lock to unlock when the state of the ignition indicates that the ignition is off.

4. The system of claim 2, further including a third component configured to sense a state of a fuel cap of the fuel entry port, wherein the second component is configured to emit a signal that inhibits the ignition from turning on when the fuel cap is removed.

5. The system of claim 4, wherein the second component is configured to turn the ignition off when the fuel cap is removed.

6. The system of claim 5, further including at least one wireless communication device that communicates with an apparatus external to the vehicle, and the second component is configured to selectively provide access to the fuel entry port based on the state of the external apparatus.

7. The system of claim 6, wherein the second component is configured to selectively control the power state of the external apparatus based on the state of the fuel cap.

8. The system of claim 6, wherein the at least one wireless communication device is a radio frequency identification (RFID) reader.

9. The system of claim 6, wherein the external apparatus is a cell phone.

10. The system of claim 6, wherein the at least one wireless communication device receives information indicative of a state of a fuel pump, and the second component is configured to inhibit the vehicle from being started when fuel is being dispensed from the fuel pump.

11. The system of claim 1, wherein the first and second components are part of a computing system of a fuel pump, and the second component is configured to selectively allow fuel to be dispensed from the fuel pump based on the state of the ignition.

12. The system of claim 11, wherein the second component is configured to inhibit fuel from being dispensed from the fuel pump when the ignition is on.

13. The system of claim 11, further including a wireless communication device configured to receive information from the vehicle, wherein the information is indicative of the state of the ignition of the vehicle.

14. The system of claim 13, wherein the wireless communication device is a RFID reader that reads a tag of the vehicle.

15. The system of claim 1, where the vehicle is an automobile.

16. A method for facilitating fueling of a vehicle, comprising:
sensing a state of an ignition of the vehicle; and
affecting the ability to add fuel to the vehicle based on the state of the ignition.

17. The method of claim 16, wherein sensing the state and affecting the ability to add fuel are performed within a computing system of a vehicle.

18. The method of claim 17, wherein affecting the ability to add fuel includes inhibiting access to a fuel entry port of the vehicle when the ignition is on.

19. The method of claim 17, wherein affecting the ability to add fuel includes inhibiting the ignition from turning on when a fuel cap is removed.

20. The method of claim 17, wherein affecting the ability to add fuel includes inhibiting the ignition from turning on when fuel is being added to the vehicle.

21. The method of claim 16, wherein sensing the state and affecting the ability to add fuel are performed within a fuel pump.

22. The method of claim 16, wherein affecting the ability to add fuel includes inhibiting fuel dispensing when the ignition is on.

23. A method, comprising:
producing computer executable program code;
storing the code on a computer readable medium; and
providing the program code to be deployed and executed on a computer system;
the program code comprising instructions which, when executed on the computer system, cause the computer system to:
sense a parameter indicative of a state of an ignition of a vehicle, wherein the state indicates whether the ignition is on or off; and
allow fuel to be added to the vehicle when the ignition is off and inhibit fuel from being added to the vehicle when the ignition is on.

24. A method for deploying an application for facilitating fueling a vehicle, comprising:
providing a computer infrastructure being operable to:
sense a parameter indicative of a state of an ignition of the vehicle, wherein the state indicates whether the ignition is on or off; and
allow fuel to be added to the vehicle when the ignition is off and inhibit fuel from being added to the vehicle when the ignition is on.
